(19) United States
(12) Patent Application Publication
(10) Pub. No.: US 2011/0183096 A1
(43) Pub. Date: Jul. 28, 2011

(54) Foamed Airstream Surface Duct Product

(76) Inventors: Michael J. Lembo, Souderton, PA (US); John Bozek, Harleysville, PA (US); Renee Chesler, Royersford, PA (US)

(21) Appl. No.: 12/695,340

(22) Filed: Jan. 28, 2010

(51) Int. Cl. B32B 1/08; B29D 22/00

(52) U.S. Cl. 428/36.5; 156/213

(57) ABSTRACT

The present invention provides insulation duct products including an insulation layer containing fibrous material bound with a resinous binder, an inner surface and an outer surface, and a closed cell foam layer adhered to an inner surface of the insulation layer. The closed cell foam layer includes a thickness of less than 0.5 inches (1.27 cm), and has a density of less than about 12 pcf.

### FIELD OF THE INVENTION

The present application relates, in general, to building material products and, in particular, to fibrous air duct products and methods for making same.

### BACKGROUND OF THE INVENTION

Ducts and conduits are used to convey air in building heating, ventilation and air conditioning (HVAC) systems. In many applications, especially in commercial and industrial construction, the ducts are lined with flexible thermal and sound insulating material. The lining enhances the thermal efficiency of the duct work and reduces noise associated with movement of air therethrough. Duct liner may comprise any suitable organic material or inorganic material, e.g., mineral fibers such as fiber glass insulation or the like. Typical fiber glass duct liners, for example, are constructed as fiber glass mats having densities of about 1.5 to 3 pounds per cubic foot (pcf) and thicknesses of about 0.5 to 2 inches. To prevent fiber erosion due to air flow, the insulation may include a water resistant resinous coating on its inner or “airstream” surface. The airstream surface of the insulation is the surface that conveys air through the duct and is opposite the surface that contacts the duct sheet metal in the final duct assembly. The resinous coating also serves to protect the insulation during brush and/or vacuum cleaning of the interior of the duct. Examples of duct liners having resinous coatings on their inner surfaces are provided in U.S. Pat. Nos. 3,861,425 and 4,101,700. Several coated insulation duct liners are marketed under the trade designations ToughGard® by CertainTeed Corp. of Valley Forge, Pa.; Aeroflex® and Aeromat® by Owens Corning Fiberglas Corp. of Toledo, Ohio; Permacote®, and Polycoustic™ by Johns Manville Corp. of Denver, Colo.

Other insulated HVAC systems use ducts either fabricated from or lined with rigid duct boards or tubes. Duct boards are rigid members formed from resin-bonded mineral and Aeromat® by Owens Corning Fiberglas Corp. of Toledo, Ohio; Permacote®, and Polycoustic™ by Johns Manville Corp. of Denver, Colo.

Other insulated HVAC systems use ducts either fabricated from or lined with rigid duct boards or tubes. Duct boards are rigid members formed from resin-bonded mineral fibers and may also be provided with protected coatings on their airstream surfaces. Duct boards typically have densities of about 3 to 6 pounds per cubic foot (pcf) and thicknesses of between about 0.5 to 2 inches. Coated and uncoated duct boards are marketed under a variety of trade designations from the aforementioned manufacturers of duct liners.

As an alternative to coated duct liners and duct boards, at least CertainTeed Corp. and Knauf Fiber Glass GmbH offer duct liners or duct boards having glass fiber insulation covered with a layer of non-woven facing material which defines the airstream surface of those products. The facing material produces a durable surface that protects the air duct from fiber erosion. Both coated and faced fibrous insulation duct products possess limited moisture resistance and may be susceptible to microorganism formation in the event they become wet.

Heisey et al., U.S. Pat. No. 5,971,034, (Heisey '034) discloses a duct lining insulation system for lining metal air volume boxes and handling units. The disclosed duct lining insulation contains a flexible, closed cell foam composition having a smooth face on its airflow side, and a pressure sensitive adhesive for adhering to the inside of the metal duct work. It is provided in thicknesses of about 1 inch, and is often used in schools, hospitals, hotels, commercial and public buildings for its sound reduction and anti-microbial properties. In practice, cutting such a thickness of foam requires a lot of effort, and the resulting weight of the dense foam, not to mention the metal duct work, makes the system extremely heavy.

Accordingly, there remains a need for an improved airstream surface for duct liners and duct boards.

### SUMMARY OF THE INVENTION

The present invention provides an insulation duct product comprising an insulation layer containing, fibrous material bound with a resinous binder, an inner surface and an outer surface. Adhered to the inner surface of the insulation layer is a closed cell foam layer. The closed cell foam layer has a thickness of less than 0.5 inches (1.27 cm), and has a density of less than about 12 pcf.

The present invention provides an improved airstream surface for duct liners and duct boards having a closed cell foam layer which is very thin, preferably less than 0.05 inches, and more preferably, in the range of about 1/32 to about ⅛ inches in thickness. The closed cell foam layer substantially covers the inside surface of the duct liner or duct board. The insulation layer may contain rotary or textile glass fibers, or a combination of such fibers containing glass or mineral wool, for example. The product may also include a ship lap edge and a facing layer adhered to the outer facing surface of the insulation layer, such as an aluminum foil reinforced with glass scrim.

The preferred airstream surface of this invention has a very low moisture absorbency, is cleanable and is microbial resistant. When fabricated as a duct board, the present invention is a complete substitute for the steel and foam duct system offered by Heisey '034, with an intended reduction in weight, labor cost and material cost. The duct board can be completely self supporting, and the closed cell foam allows for bending of the airstream surface and pinching at the corners without difficulty.

In a further embodiment of the present invention, the duct product can include a closed cell foam layer having a thickness of about 0.0625-0.125 inches. The product can be colored black so that it is less visible from the view point of a room being conditioned by an airstream from said duct work. The preferred closed cell foam layer is non-wicking and non-dusting and may contain a combination of polyvinyl chloride and nitrile rubber. The closed cell foam layer composition is suitable for lining duct board, duct liners or liner boards, and has an R-value within about 20% of the R-value for the insulation layer.

In a further embodiment of the present invention, the method of making a duct product is provided. The method includes preparing an insulation layer, having inner and outer surfaces, from fibrous material bound with a resinous binder. The method further includes the step of adhering a closed cell foam layer to said inner surface of the insulation layer and, optionally, including a facing layer on the outer surface of the insulation layer. The method can further include using a low VOC adhesive to bond the closed cell foam layer to the insulation layer. The closed cell foam layer and its adhesive can be applied continuously to the insulation layer during the manufacture of the duct product.

### BRIEF DESCRIPTION OF THE DRAWINGS

The invention will become more readily apparent from the following description of preferred embodiments thereof shown, by way of example only, in the accompanying drawings wherein:

FIG. 1 is an exploded view of an insulated air duct product constructed according to the present invention; and

FIG. 2 is a schematic view of an apparatus for manufacturing a duct board in accordance with the present invention.

### DETAILED DESCRIPTION OF THE INVENTION

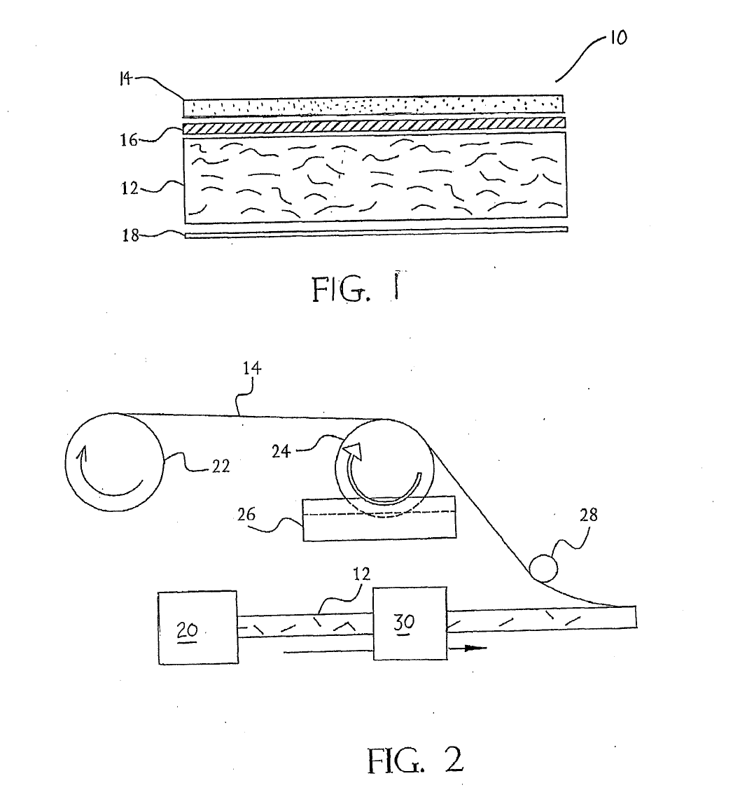

Referring to FIG. 1, there is shown a segment of an insulated air duct insulation product 10 in accordance with the present invention. Product 10 may be a flexible duct liner, rigid duct board or tube comprising an insulation layer 12 of inorganic fibers such as glass fibers, refractory fibers or mineral wool fibers bonded by a suitable resin and a closed cell foam layer 14 adhered thereto by adhesive 16, for example, wherein the closed cell foam layer 14 defines the airstream surface for the liner, board or tube. Binders that may be used to bind the fibers of the insulation layer 12 may include, without limitation, the phenolic binders disclosed in U.S. Pat. Nos. 5,300,562 and 5,473,012, the disclosures of which are incorporated herein by reference. An example of such a resin is a phenol-formaldehyde resin, wherein a mole ratio of formaldehyde to phenol is from about 2.5:1 to 4.2:1. Optimally, phenolic-free binders, such as nylon and acrylic-based binders, can be used. Product 10 may have a density of about 1.5 to 3 pounds per cubic foot (pcf) for duct liner and about 3 to 6 pounds per cubic foot (pcf) for duct board and liner board, and a thickness of about 0.5 to 2 inches. The thickness and density of insulation layer 12 will be dictated by the levels of acoustic and/or thermal insulation that are desired or necessary for a particular building installation. The insulation layer 12 of the duct liner, board or tube, is preferably rendered further water-repellent by incorporating a hydrophobic agent into adhesive 16. The closed cell foam layer 14 is preferably moisture resistant, if not moisture repellent. Preferably, a foil/scrim/paper or other suitable vapor retarder layer 18 can be adhered or otherwise affixed to the outer face of insulation layer 12 opposite the closed cell foam layer 14 to prevent moisture from entering the insulation from the ambient environment.

Referring to FIG. 2, as is conventional, the insulation layer 12 may be made in a forming station 20, such as for example, by melt spinning molten material, such as glass, into fine fibers, or by air laying textile and/or rotary fibers, and spraying a binder, such as a phenolic on non-phenolic resin binder in an aqueous carrier, onto the fibers, and collecting the fibers as a web on a conveyor. The web is then passed through a conventional curing oven 30 or other means for curing and compressing the web to a desired thickness after the web exits the forming station 20. While in the oven 30, insulation layer 12 is heated in order to cure the binder. Preferably, insulation layer 12 is pressed together by unillustrated heated platens or the like.

In the process of the present invention, a continuous web of foam layer 14 is then dispensed from a roll 22 and is applied to one surface of insulation layer 12 generally after curing of the binder in the insulation. Prior to adhering the foam layer 14 to the insulation layer 12, an adhesive is applied to either or both of the foam layer 14 and the insulation layer 12. According to a presently preferred arrangement, adhesive is continuously applied to the underside of foam layer 14 via an applicator roll 24 rotatably supported in a pan 26 or similar receptacle which contains adhesive appropriate for securely adhering layers 12,14 to one another. It will be understood that adhesive may be applied to either or both of layers 12,14 by other means such as spraying or brushing. Although not limited thereto, a preferred adhesive is a low VOC adhesive, such as a water-based adhesive, for example, polyvinyl acetate or acrylic.

The adhesive used to attach foam layer 14 to insulation layer 12 preferably may include at least one hydrophobic agent such as silicone, oil, fluorocarbon, waxes or the like in an effective amount sufficient to render the adhesive essentially impermeable to water and resistant to aqueous solutions containing moderate quantities of solvent. Effective amounts of hydrophobic agent may range in a ratio of about 1:20 to 1:200, and more preferably about 1:40, hydrophobic agent to binder. A commercially available hydrophobic agent suitable for these purposes is DC 347 silicone emulsion manufactured by Dow Corning Corporation of Midland, Mich.

The layers 12, 14 may travel at any desired synchronous speed, and the applicator roll 24 may be rotated at any speed sufficient to thoroughly apply the adhesive to the underside of the moving foam layer 14. Preferably, the foam layer 14 is not stretched or drawn in too much tension, since this will lead to distortion if the foam layer 14 contains rubber or other resilient material. A placement means 28 such as an idler roller or the like may be used to facilitate placement of the foam layer 14 on insulation layer 12. Product 10 is then passed by an unillustrated conveyor. Vapor retarder layer 18 (not shown in FIG. 2) may be applied to the surface of insulation layer 12 opposite foam layer 14 after the insulation board exits the curing oven.

Alternatively, the foam layer 14 can be applied in situ as a liquid film containing a foaming agent, for example, which is activated upon ambient pressure or heat of the product, for example, to form a foam layer 14 bound to the insulation layer 12, so as to not require an adhesive between the foam layer 14 and insulation layer 12.

Moreover, although illustrated herein as it would appear when manufactured as a planar duct board or liner, product 10 may also be formed into a tubular shape by any suitable techniques known in the art. In an embodiment of the invention, the product may alternatively be constructed and function as an insulated duct tube or tubular duct liner. In such a construction, a hinge region or regions can be provided in the insulation layer by partially cutting the insulation 12. The hinge region or regions can optionally be devoid of foam for bending about each hinge region,

### Foam Layer

Foam polymers and elastomers are well known, and can be prepared according to methods known in the art. Elastomer foams, for example can be prepared according to the methods found described in “Rubber Technology” edited by Maurice Morton, published by Van Nostrand Reinhold (87), or as described in U.S. Pat. No. 5,114,987.

Although rigid and/or open celled foamed materials can serve the purpose of the present invention, the polymer or elastomer for the foam layer 14, however, is desirably flexible and closed cell. As duct insulation, the foam suitably has a maximum thermal conductivity of about 0.0576 watt/meter degree K (W/M degree K), and preferably, has a maximum of about 0.0504 W/M degree K.

The foam layer 14 can be about 1/32 to about ½ inch thick, and preferably, is about 1/16-¼ inch thick. It has a density of preferably less than 12 pcf and, more preferably, about 3-6 pcf when tested according to ASTM D 1662, 1667. For most insulation needs the duct product 10 can be set at a sheet thickness of up to about 2-2.5 inches thick.

The foam layer 14 used can be an elastomer, and preferably, it is a nitrile and polyvinyl chloride elastomer foam composition, or cross-linked polyethylene or polypropylene foam. These resins are preferred as duct insulation since they can be given excellent fire and smoke properties. This can be done by the addition of materials selected from the group consisting of an aluminum trihydrate (alumina), an antimony fire retardant such as antimony trihydrate, a halogen compound, and mixtures thereof.

The standard test method for surface burning characteristics of building materials, ASTM E-84, can be used to determine the fire and smoke characteristics. Preferred duct insulation of product 10 of the present invention will have a smoke developed index of 50 or less and a flame spread index of 25 or less. These levels can be achieved in the foam layer 14, for example, by using an elastomer blend containing nitrile rubber and PVC (polyvinyl chloride) with from about 24 to about 33% by weight of aluminum trioxide and from about 0.25 to about 1.25% by weight of antimony trioxide.

Suitable elastomer blend foams include a nitrile rubber in an amount in the range of about 0-30 wt. %, preferably about 10-27 wt. %, and PVC, polyethylene or polypropylene in an amount in the range of about 14-18 wt. %. In such elastomers, plasticizers can be used in an amount in the range of about 10-16 wt. %; fillers, including carbon black and the aluminum trioxide and antimony trioxide can be used in an amount in the range of about 24 to about 37 wt. %; processing aid and antioxidant package can be used in an amount in the range of about 2-7 wt. %; curing agent can be used in an amount in the range of about 1 to about 5 wt. %; and blowing agent can be used in an amount in the range of about 10-14 wt. %.

The preferred duct insulation of the present invention will also pass the hot surface test, ASTM C-411, at 250° F., and continuous use at temperatures of about 180° F. The nitrile rubber and PVC elastomer is preferably used when it is desired to have a foam insulation that will pass this test.

The foam layer 14 of the present invention preferably absorbs less than about 1% water, and more preferably, about 0.2% or less when tested in accordance with ASTM C209, and has a water vapor permeability, perm-in. (Kg/(s·m·Pa)) of about 0.05 (0.725×10⁻¹³) in accordance with ASTM E96 (Procedure A). A preferred foam is AP Armaflex SA Black Duct Liner foam, available from Armacell LLC, Mebane, N.C.

Although the invention has been described in detail for the purpose of illustration, it is to be understood that such detail is solely for the purpose and that variations can be made therein by those skilled in the art without departing from the spirit and scope of the invention except as it may be limited by the claims.

What is claimed:

1. An insulation duct product comprising:
an insulation layer containing fibrous material bound with a resinous binder, an inner surface and an outer surface; and
a closed cell foam layer adhered to an inner surface of said insulation layer, said closed cell foam layer having a thickness of less than 0.5 inches (1.27 cm), and having a density of less than about 12 pcf.

2. The duct insulation product of claim 1 wherein said foam layer has a thickness of about 0.0625-0.125 inches.

3. The duct insulation product of claim 1 wherein said closed cell foam layer is black.

4. The duct insulation product of claim 1 wherein said closed cell foam layer is substantially non-wicking and non-ducting.

5. The duct insulation product of claim 1 wherein said closed cell foam layer comprises an elastomer containing a resin selected from polyvinyl chloride, polypropylene, polyethylene and about 0-30 wt. % nitrile rubber.

6. The duct insulation product of claim 1 wherein said insulation layer comprises inorganic fibers.

7. The duct insulation product of claim 1 wherein said product forms a duct board, duct liner or liner board.

8. The duct insulation product of claim 1 wherein said product is bent to form a tubular shape.

9. A method of making an insulation duct product, comprising:
(a) preparing an insulation layer having inner and outer surfaces, said insulation layer containing inorganic fibrous material bound with a resinous binder; and
(b) adhering a closed cell foam layer to said inner surface of said insulation layer, said closed cell foam layer having a thickness of less than 0.5 inches (1.27 cm) and having a density of less than 12 lbs/ft.

10. The method of claim 9 wherein said adhering step (b) adheres said closed cell foam layer to said inner surface of said insulation layer with a low VOC adhesive.

11. The method of claim 9 wherein said adhering step (b) adheres said closed cell foam layer continuously during the manufacture of said insulation layer.

12. The method of claim 9 wherein said closed cell foam layer comprises polyvinyl chloride, polyethylene or polypropylene.

13. The method of claim 9 wherein said insulation duct product comprises a duct board, a duct liner or liner board.

14. The method of claim 9, comprising:
bending the insulation duct product to form a tubular duct product.

15. An insulation product for a duct board or duct liner comprising:
an insulation layer containing inorganic, fibrous material, including glass fibers, bound with a resinous binder, an inner surface and an outer surface; and
a closed cell foam layer adhered to an inner surface of said insulation layer, said closed cell foam layer having a thickness of less than about 0.125 inches, and being substantially non-wicking and non-dusting, and substantially black in color.

16. The insulation product of claim 15 wherein said closed cell foam layer comprises polyvinyl chloride, polypropylene, polyethylene and about 0-30 wt. % nitrile rubber.

17. The insulation product of claim 15 wherein said closed cell foam layer has a maximum thermal conductivity of about 0.0576 watt/meter degrees K.

18. The insulation product of claim 15 wherein said duct board or duct liner has an ASTM E84 smoke developed index of 50 or less, and a flame spread index of 25 or less.

19. The insulation product of claim 15 wherein said closed cell foam layer comprises a elastomer blend containing about 14-18 wt. % polyvinyl chloride, polypropylene and/or polyethylene, and about 10-27 wt. % nitrile rubber.

20. The insulation product of claim 15 further comprising an anti-microbial agent disposed at least on said closed cell foam layer.

21. The insulation product of claim 15 wherein said insulation layer comprises an outer facing layer adhered to its outer surface.
